(19) United States
(12) Patent Application Publication
(10) Pub. No.: US 2006/0259440 A1
(43) Pub. Date: Nov. 16, 2006

(54) Method and system for electronically signing a document

(75) Inventors: Daryl Bernard Leake, Shaker Heights, OH (US); David Scott White, Sharon, MA (US); Paul Ayres, Twinsburg, OH (US); James Edward Bowser, Cleveland, OH (US); Maureen A. Milich, Elyria, OH (US); Scott Edward Norris, Lakewood, OH (US)

Correspondence Address: THOMPSON HINE L.L.P., P.O. BOX 8801, DAYTON, OH, 45401-8801, US

(73) Assignee: KeyCorp

(21) Appl. No.: 11/128,821

(22) Filed: May 13, 2005

(51) Int. Cl. G06Q 99/00

(52) U.S. Cl. 705/76

(57) ABSTRACT

A method for electronically signing a document includes the steps of accessing over a network a product page provided by a product application server, providing identification information to the product application server unique to an individual who is to sign the document, communicating information identifying a document to be electronically signed from the product application server to an electronic signature application server, verifying the individual's identity, acquiring a template of the document and populating the template with data pertaining to the individual to form a completed document and displaying the completed document on a page generated by the electronic signature application server and accessible over a network by the individual, and adding an electronic signature to the completed document to form a signed document. The signed document may be printed by the individual and may be stored as a .pdf image and also may be stored in a file that is time-stamped and hashed in a form that includes the template, signature and merged data used to populate the template.

### BACKGROUND

The disclosure relates to methods and systems for creating and electronically signing documents in electronic form and, more particularly, to methods and systems for electronically signing a financial document.

Many businesses have implemented systems to facilitate the creation, execution and storage of documents electronically. Changes in applicable laws have enabled banks and other financial institutions to provide financial products, such as loans, on the basis of documents provided over communication networks, such as the Internet, that subsequently are signed electronically; that is, that are executed by the loan applicant by means other than affixing a handwritten signature to the document.

There are several benefits to electronic document creation, execution and storage to financial institutions. By providing financial services over a communication network such as the Internet, financial institutions are able to reach a much wider and larger customer base. In addition, the potential customers who apply for the financial products are able to apply for and obtain financial products from locations convenient to the customer, such as the customer's own home using the customer's home computer. Other advantages of providing financial services and products utilizing documents that are electronically signed is that the cost in terms of personnel needed to handle paperwork associated with the consideration of the application for the financial product and the handling of the document associated with providing the financial product are reduced, and the transaction is processed faster, providing a quicker turnaround to the customer.

Consequently, there are many methods and systems available for use in executing documents over a network available to financial institutions. However, it is also desirable to provide an applicant who elects to obtain a financial product over a network with the option of declining to complete the electronic signature process and instead printing out a loan or other financial product document to which the applicant may affix his or her handwritten signature (known as “wet signing”) to the document. There is also a need to provide a method and system for electronically signing a document that enables a co-applicant or co-signer to participate in the electronic application process. Such co-applicant should also have the option of obtaining a printout of the document should that co-applicant elect to “wet sign” the document rather than sign it electronically.

### SUMMARY

The method and system for electronically signing a document enables an individual to access over a network a product page provided by a product application server, provide identification information to the product application server unique to the individual who is to sign the document, communicate information identifying the document to be electronically signed from the product application server to an electronic signature application server, verify the individual's identity, acquire a template of the document and populate the template with data pertaining to the individual to form a completed document and display the completed document on a page generated by the electronic signature application server and accessible over a network by the individual, and add an electronic signature to the completed document to form a signed document.

The method and system for electronically signing a document is capable of providing an applicant the option of declining to complete the electronic signature process and printing and wet signing the document, after which the applicant may submit the hard copy wet-signed document to the issuing party. The applicant also has the option of wet-signing the document in the event that, for example, incorrect identification or authentication information is given, thereby terminating the electronic signature process.

The method and system of electronically signing a document may include a further step of storing a file that includes a time-stamped and hashed version of the document that includes the template, signature and data pertaining to the individual that is used to populate the template. Subsequently, an image of the executed document is stored in an image database.

Another aspect of the method and system of electronically signing a document is particularly suitable for use by banks and other financial institutions in processing financial documents such as notes, mortgages and loans, especially student education loans, opening checking and savings accounts, boat and auto loans, personal lines of credit, purchasing certificates of deposit, home equity loans and lines of credit, overdraft protection, individual retirement accounts (“IRAs”) and other financial products.

In such an application, an aspect of the invention enables an applicant for a financial product to elect to include a co-applicant. The applicant may provide identification and contact information of the co-applicant, including an e-mail address. After the applicant completes the electronic signature process, the co-applicant may then be notified by e-mail and provided access information, including a reference number unique to the document to be co-signed, and a network or Internet link to a sequence of pages relating to an application to be filled out by the co-applicant.

The co-applicant may then proceed to provide identification information, both of a “wallet-type” (basic identification such as name, address, telephone number, Social Security number, driver's license number and the like) and “non-wallet-type” information (more private information, such as information pertaining to the number and types of mortgages held by the co-applicant, automobile ownership and loan payment information and the like). Both the wallet-type and non-wallet-type information may be used to authenticate the co-applicant; that is, to insure that the individual representing himself or herself as a co-applicant is who he or she says he or she is. In such a process, as with the applicant signature process, the co-applicant is also given the opportunity to decline the electronic signature process and print out and “wet sign” a loan document at any time during the process. A benefit of this aspect of the system is that the co-applicant need not participate in the signature process at the same geographic location as the applicant, or even at the same time as the applicant, thereby adding flexibility to the overall process not present in prior art systems.

The system for electronically signing a document may include a product application server that communicates over a network or the Internet with an individual who is to sign the document, who may be an applicant for a loan from a bank or financial institution. The product application server communicates with a middleware application server that, in turn, communicates with an electronic signature or “e-sign” application server. The product application server includes product web pages that are displayed on the home computer of the individual or applicant and include information regarding the financial instrument that is the subject of the electronic signature process, collect basic identification information pertaining to the applicant, and provide the applicant with an electronic signature reference number. The product application server also may communicate the reference number by way of e-mail.

The e-sign application server provides web pages to the individual as part of the signing process, and includes associated record storage for storing a time-stamped and hashed version of the financial or other document signed by the individual.

The system also may include an imaging application server that stores the document in a .pdf or other format for purposes of customer service; that is, in the event that the customer or applicant wishes to obtain a copy of the executed document.

The system also may communicate with an authentication application server that may be provided by a third party, such as Equifax, Inc. of Atlanta, Ga. This service accesses a database of confidential wallet and non-wallet type information pertaining to the applicant. Such an authentication server may provide authentication information to the e-sign application server in the form of multiple-choice questions regarding non-wallet-type information that are answered by the applicant and conveyed through the e-sign application server to the authentication server. In response, the authentication server provides a score and explanatory codes to the e-sign application server and the e-sign application server applies predetermined business rules to the score. A decision on whether or not to proceed with the electronic signature process is made by the e-sign application server based upon the score, which reflects the accuracy of answers to the multiple choice questions provided. This process is performed to ensure that the applicant performing the e-sign process is who he says he is.

The system may also include a document template application server that stores the documents that may be executed electronically. Such documents may include loan documents and deposit products and there may exist different versions depending upon the geographic location of the applicant. The selection of the appropriate document is made by the product application server; the document templates are stored in storage associated with the document template application server.

Other advantages of the method and system for electronically signing a document will be apparent from the following description, the accompanying drawings and the appended claims.

### BRIEF DESCRIPTION OF THE DRAWINGS

FIG. 1 is a schematic representation of a system for electronically signing a document, showing an interface with a customer home computer and a customer service representative workstation;

FIG. 2 is a flow chart showing the process for applying for a financial product;

FIG. 3 shows a web page generated by the process representing information provided by an applicant in a loan application;

FIG. 4 is a continuation of the flow chart shown in FIG. 2 and displays the electronic signature process;

FIGS. 5 and 5A each show a “Getting Started” page of the process, wherein the page of FIG. 5 results from correct input of any assigned passcode and FIG. 5A results from incorrect input or no input of an assigned passcode;

FIG. 6 shows an “Identification Information” page of the process;

FIG. 7 is a continuation of the flow chart of FIG. 4 and relates to the process, specifically document display;

FIG. 8 is a “Print Documents” page of the process;

FIG. 9 is an “Electronic Signature Disclosure” page of the process;

FIG. 10 is an “Authentication Disclosure” page of the process;

FIG. 11 is a flow chart that is a continuation of the flow chart of FIG. 7 and is directed to identification and authentication of the applicant;

FIG. 12 is an “Authentication Information” page of the process;

FIG. 13 is an “Authentication Questions” page of the process;

FIG. 14 is a flow chart that is a continuation of the flow chart of FIG. 11 and is directed to the electronic signature phase of the process;

FIG. 15 is a “Sign Documents” page of the process;

FIG. 16 is a continuation of the flow chart of FIG. 14 and is directed to display of the signed document;

FIGS. 17 and 17A are “Confirmation” pages of the process in which the page FIG. 17 enables an applicant to print a document in .pdf format and the page of FIG. 17A does not;

FIG. 18 is a “Thank You” page of the process of the present invention;

FIG. 19 is a flow chart of the process for registering an additional signer to the document shown in FIG. 15 who may either e-sign or wet sign the document;

FIG. 20 is a “System Unavailable” page of the process;

FIGS. 21 and 21A are alternate “Credit Results” pages of the process;

FIG. 22 is a “Signing Option” page of the process; and

FIG. 23 is a “Sign Paper Documents” page of the process.

### DETAILED DESCRIPTION

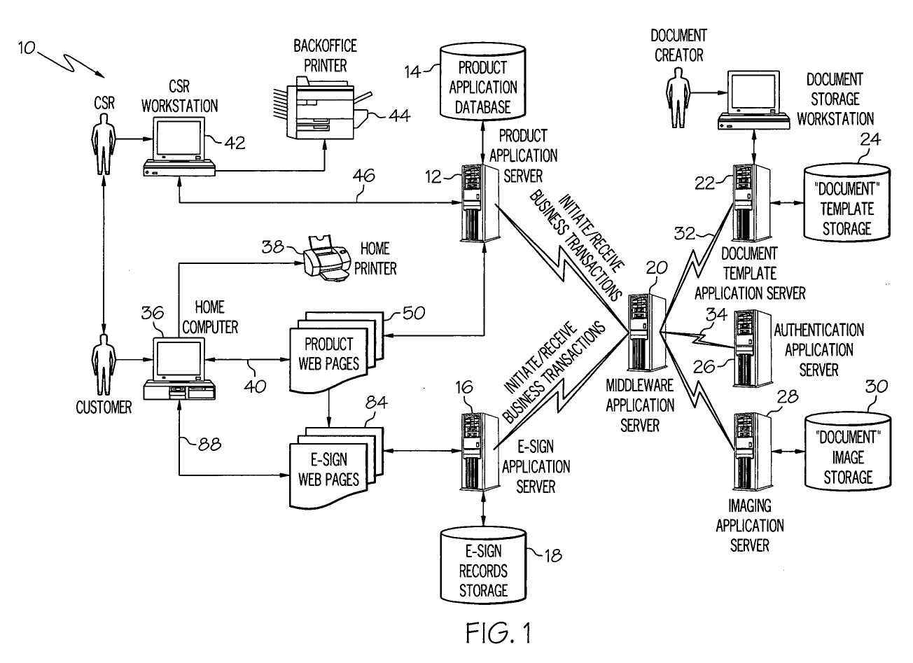

As shown in FIG. 1, the method and system for electronically signing a document, generally designated 10, may utilize a system of servers that includes a product application server 12 with an associated product application database 14, electronic signature or “e-sign” application server 16 with associated records storage database 18, middleware application server 20, document template application server 22 with associated document template storage 24, authentication application server 26 and imaging application server 28 with associated document image storage database 30. The product application server 12, e-sign application server 16, middleware application server 20, document template application server 22 and imaging application server 28 may be interconnected on a local area network or LAN, generally designated 32. The authentication application server 26 may be provided by a third party and connected to middleware application server 20 by a wide area network or WAN 34.

The product application server 12 may be accessed by the home computer 36 of a customer, who may be an applicant for a loan from a financial institution that provides the electronic signature method and system. A printer 38 is associated with the home computer 36 and optionally may be used to print documents viewed by the customer or applicant. The home computer 36 may access the product application server through a network such as the Internet 40.

In another aspect, the method and system for electronically signing a document may be accessed by a workstation 42 of a professional such as an employee or customer service representative. In the case of a financial institution providing a financial document such as a student loan note, the customer service representative may be a bank employee. Such workstation 42 may have associated with it a back office printer 44 for printing confirmatory documents or, should the applicant elect to “wet sign” the document, for printing an unsigned document. Such a workstation may access the product application server through a network 46 that may be a WAN, LAN or the Internet.

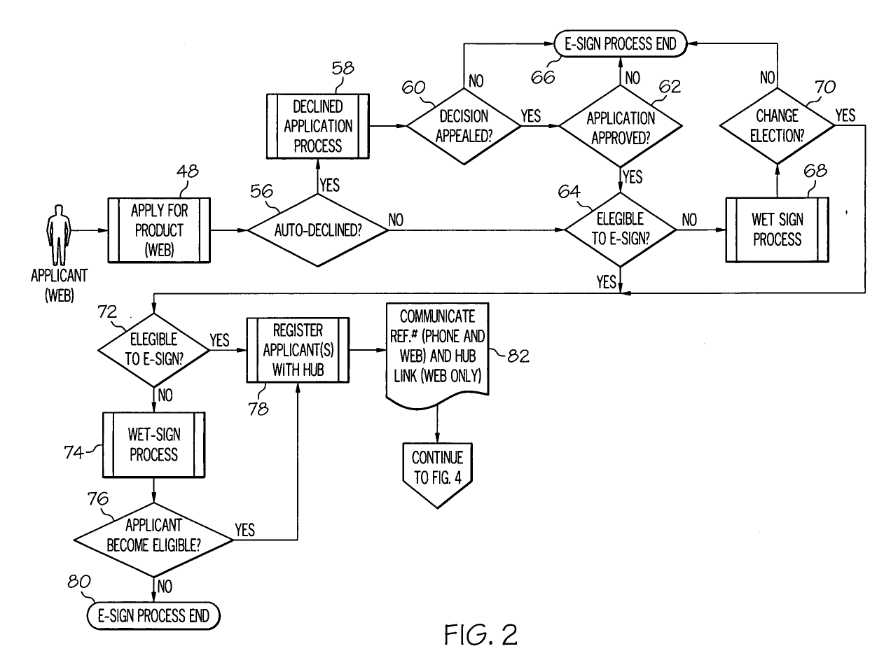

The process for qualifying for and electronically signing a document, such as a financial document, including a student loan note, begins with the application process shown in FIG. 2. In block 48, the applicant may initiate the application procedure by accessing the product application server 12 (FIG. 1) through his or her home computer 36 over a network such as the Internet 40. The product application server may provide a menu page and the applicant is prompted to select the type of product desired. While the following description of the application and electronic signature process will be described with reference to an applicant for an education loan, it is to be understood that the invention is not limited to education loans and may be employed for any type of financial product that requires an applicant to execute a document, such as a note, title, deed or mortgage. Moreover, the invention may also encompass any other type of commercial transaction that requires an electronic signature, such as a contract.

The applicant views the product web pages, generally designated 50 (FIG. 1), and elects to apply for a student loan. At this time, the applicant is prompted to provide information necessary to complete a loan application, including whether or not a co-applicant is desired, the state where the school to be attended is located, the type of school, the name of the school, the academic period for which the loan is desired and the loan amount. The applicant at this time is also prompted to provide information regarding the applicant's name, date of birth, Social Security number, citizenship, address, length of time at the address, current mailing address and home and alternate telephone numbers. The applicant is also prompted at this time to indicate whether or not he or she intends to sign the loan documents on-line. If the answer is in the affirmative, the applicant is prompted to provide an e-mail address.

The applicant is prompted to provide the remaining information necessary to complete a loan application, which may include employment information (for example, full or part time, employer name, occupation, length of employment, employment history and monthly income) and housing information (for example, rent or own, total monthly payments and number of dependents claimed on applicant's tax return).

If the applicant has indicated that a co-applicant also will sign the agreement, at this time the applicant may be prompted to provide the name, date of birth, Social Security number and citizenship of the co-applicant, along with other wallet-type information such as permanent address, length of time at the address, home and alternate telephone numbers and whether or not the co-applicant wishes to electronically sign the document. If the answer is in the affirmative, the applicant may be prompted to provide an e-mail address of the co-applicant.

Additional information pertaining to the co-applicant may also be obtained (for example, full or part time employment, name of employer, occupation, length of employment and gross monthly income) and housing information (for example, rent or own, total monthly payments, mortgage holder, number of dependents).

The applicant may then be prompted to provide information on whether he or she intends to apply for joint credit. The application process information gathering stage may end with the applicant providing information about the student who is to benefit from the loan (for example, name of student, Social Security number and expected graduation date).

The applicant may then be shown the details of the privacy policy of the financial institution providing the loan and asked to accept or decline the provisions relating to sharing of information. The applicant may then be shown an account disclosure form and asked to indicate acceptance by clicking an “ACCEPT” button.

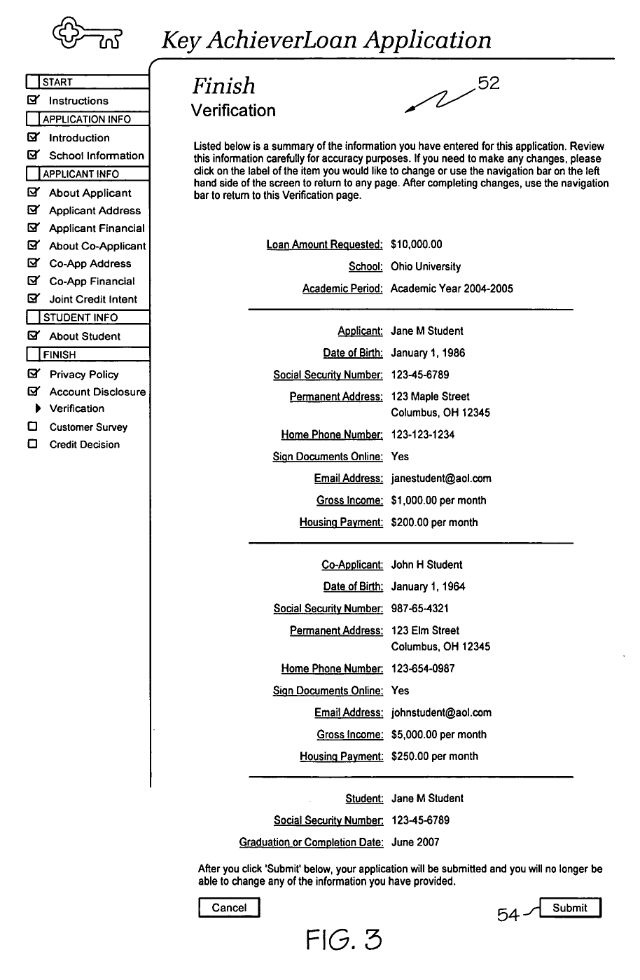

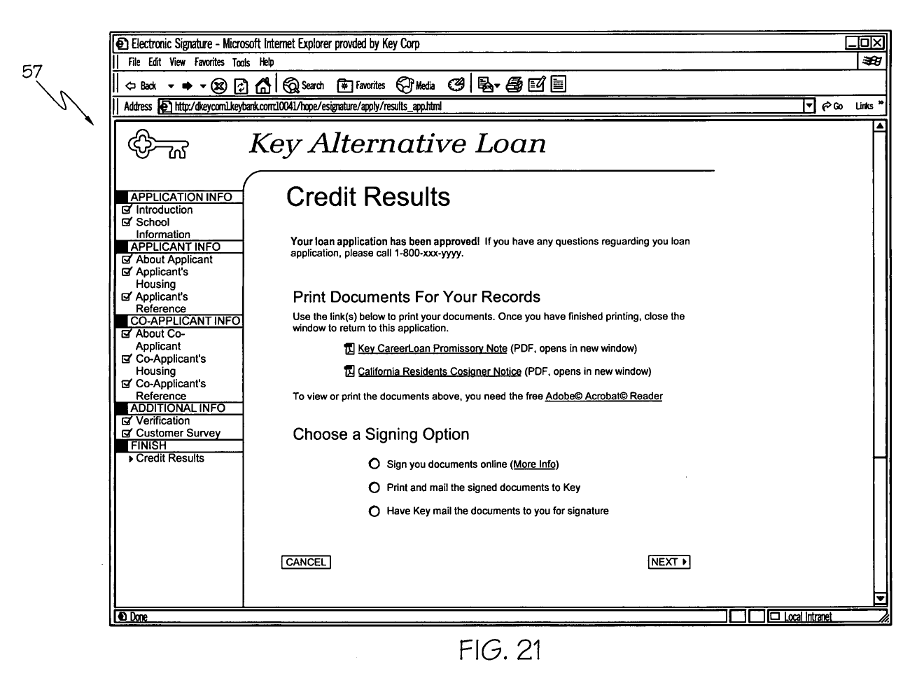

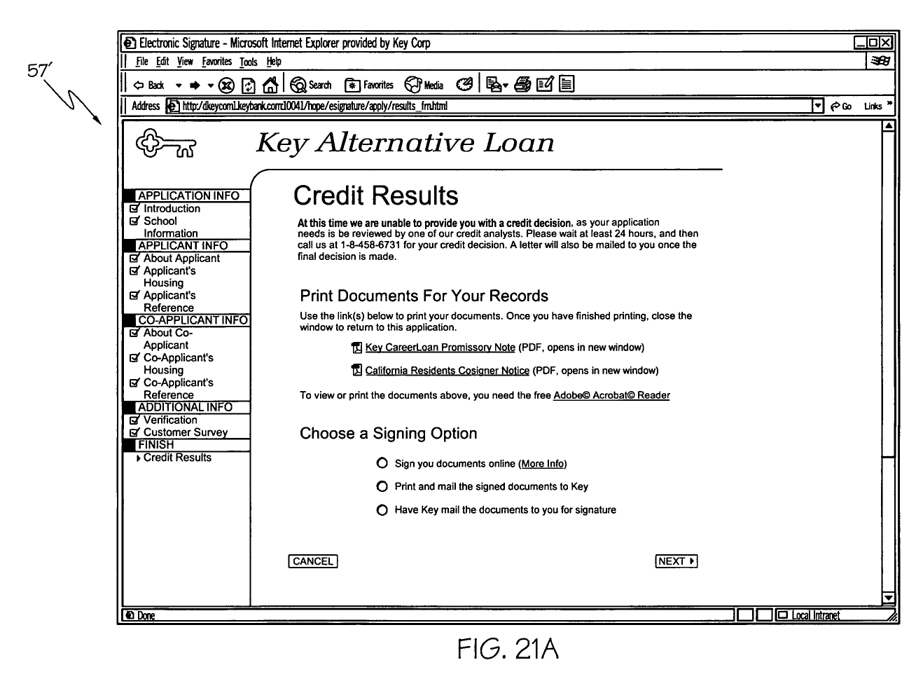

As shown in FIG. 3, the applicant at this time may be shown a page 52 that provides a summary of all of the information provided by the applicant regarding the applicant, the co-signer or co-applicant (if any) and the student and asked to click a “SUBMIT” button 54 to submit the information for verification. As shown in FIG. 1, the information may be communicated to the product application server 12. As shown in FIG. 2, at diamond 56, an immediate decision may be made to accept or decline the application. This decision may be based, for example, upon prior history with the particular applicant, or an indication that some of the information provided is inaccurate, such as the Social Security number. As shown in FIG. 21, if the application is approved, page 57 is displayed, which gives the applicant the choice of (1) electronically signing the documents, (2) printing the documents, signing them and then mailing them to the lender or (3) having the lender mail the documents to the applicant for signature and return.

However, if the decision to grant the loan and permit e-signing is declined at this time, as shown in FIG. 21A, page 57″ is displayed in which the applicant may pursue a declined application process indicated in block 58. In the course of that declined application process, as indicated in decision diamond 60, the applicant may elect to appeal the decision (e.g., by speaking with a credit analyst) and, if the appeal is approved, as indicated in decision diamond 62, the applicant may then be permitted to elect to e-sign the application, as indicated in decision diamond 64. However, if the application is not approved in decision diamond 62, the process for electronic signature ends, as indicated in block 66. Also, if the appeal is not undertaken by the applicant, the process ends, also as indicated in block 66. In either case the applicant may print out and wet-sign the loan application. Also, as shown in FIG. 21A, the applicant may proceed with the e-signature process while the credit decision is under review.

As indicated in decision diamond 64, if the loan application is not auto-declined, the applicant may nevertheless at that time decline to complete the electronic signature process and pursue a “wet signature” process, as indicated in block 68. If the applicant does not change the election, as indicated in decision diamond 70, the electronic signature process ends. It should be noted that, throughout this description, if the e-sign process is indicated as ending, the applicant may be permitted to print a loan application document or loan note at the applicant's home printer 38 (FIG. 1) or receive loan documents in the mail from the lender and complete the loan by submitting the printed document that is “wet signed” by the applicant to a loan office at the financial institution in question. The loan application may be processed in a conventional manner thereafter.

Referring to FIG. 2, if the applicant elects to e-sign, as indicated decision diamond 64, the product application server 12 (FIG. 1) may make an initial determination of whether the applicant is eligible to e-sign, as indicated in decision diamond 72. This decision may be made based upon the type of loan product desired and the risk rating of the educational institution to which the applicant wishes to attend, as not all loan products or educational institutions may qualify for the electronic signature process. However, if the applicant is ineligible to e-sign, the applicant may be given an option of pursuing a “wet sign” process, indicated at block 74. If the applicant thereafter becomes eligible to “wet sign,” as indicated at decision diamond 76, the applicant may be invited to register with the hub, as indicated in block 78. In the alternative, if the applicant does not become eligible, the process may end, as indicated at block 80, at which time the applicant may print and “wet sign” an application.

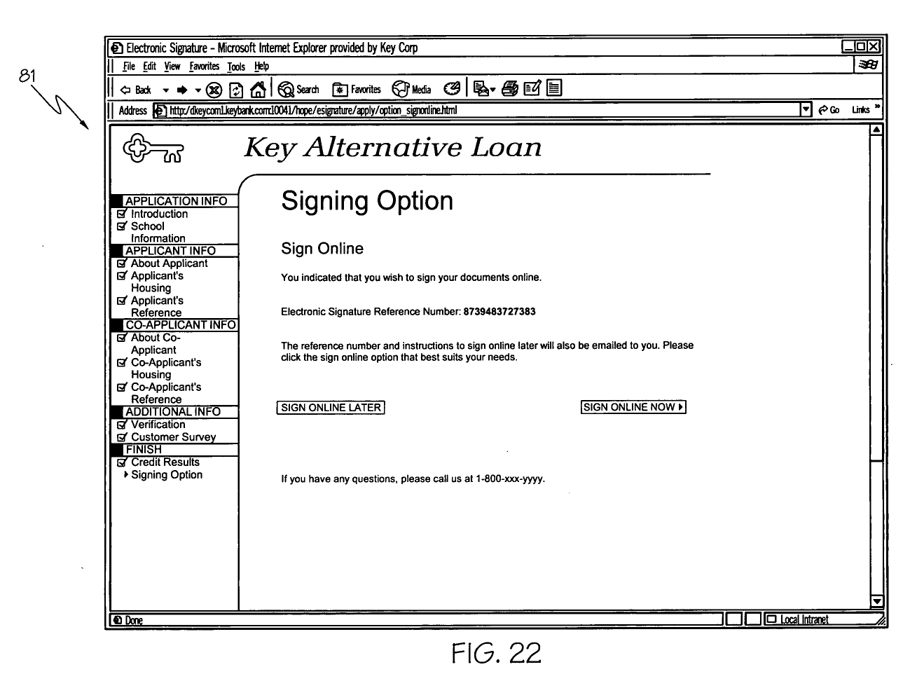

Referring to decision diamond 72, if the applicant is eligible to e-sign, the applicant then may be registered with the hub, which, as shown in FIG. 1, may include the e-sign application server 16 and records storage 18 and the e-sign process as embodied in the software resident on that e-sign application server, as will be described. As indicated at block 82 and as shown in FIG. 22, if the applicant elects to e-sign by indicating intent on pages 57 or 57′ (FIGS. 21 and 21A, respectively), page 81 is shown that provides a reference number unique to that transaction. Also, the applicant may be e-mailed the reference number and a link, preferably in separate e-mails, that will enable the applicant to interrupt the process and re-enter it at a later time.

As indicated at block 82 in FIG. 2, the applicant may then be provided with a reference number, displayed on a page 50, that is unique to the loan document, and an Internet link to the e-sign web pages, 84 (see FIG. 1) by way of two e-mails, one including the reference number and the other including the link.

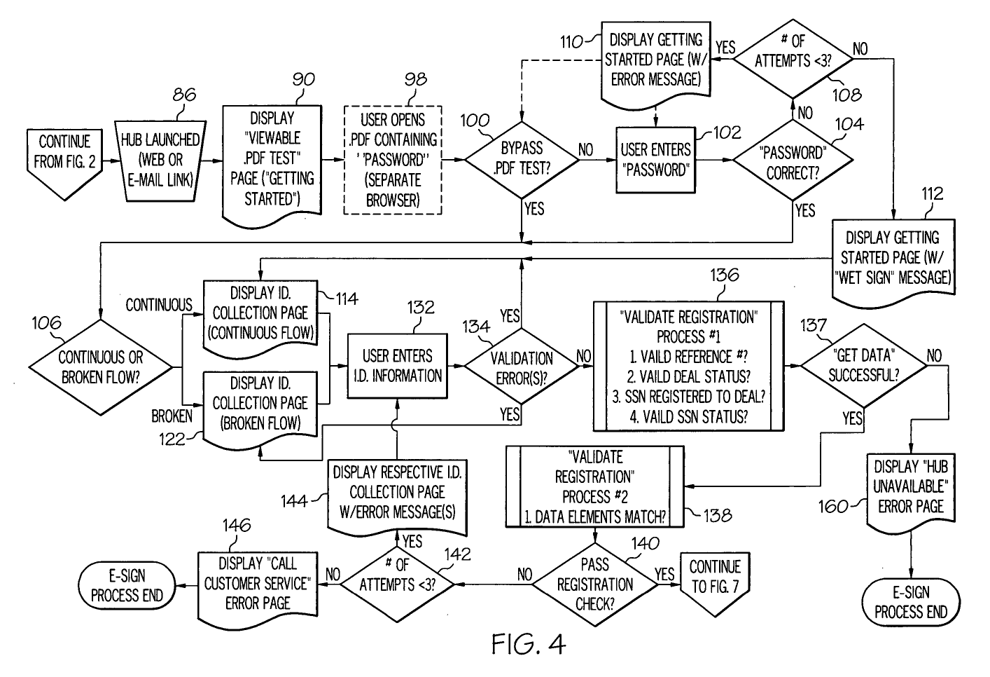

As shown in FIG. 4, once the applicant is given the reference number and link to the hub, the process may continue at block 86 at which point the applicant may be directed by the link provided at block 82 (FIG. 2) to the web pages 84 (see FIG. 1) provided by e-sign application server 16, either directly, as indicated at 88 over the Internet, or indirectly through the product application server 12. The former connection would exist if the applicant were to end the session at block 82 and restart the e-signature process at a later time. In contrast, if the process were continuous, that is, without interruption in the same session, the web pages 84 could be provided through the application server 16, middleware server 20 and product application server 12 to the home computer 36.

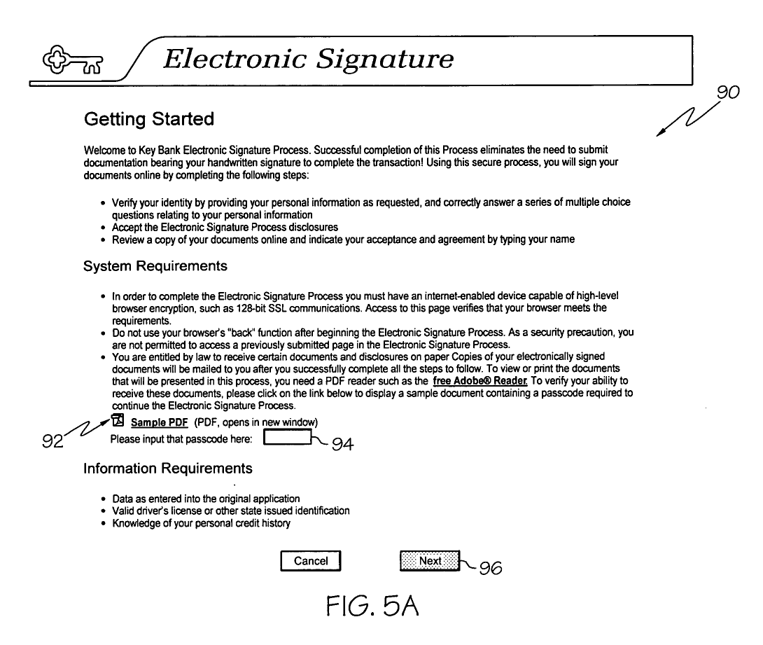

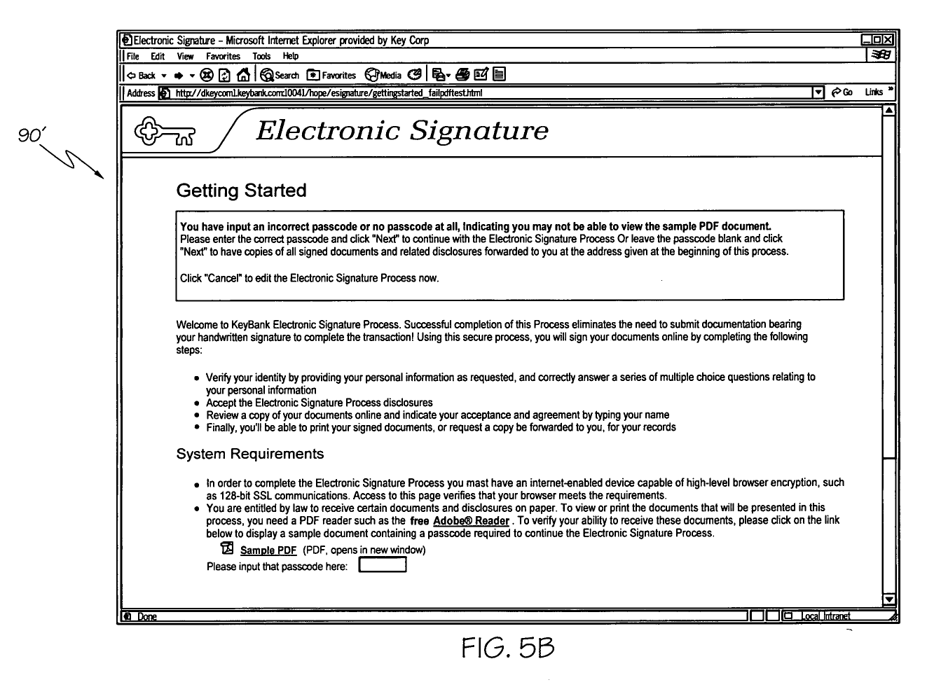

At this time, as indicated in block 90, the application server 16 may display a “Getting Started” page, shown in FIG. 5. This page may provide information to the applicant pertaining to the remainder of the process, which may involve verifying identity, accepting the disclosures, reviewing a copy of the document and printing the electronic signature. The page also may display the minimum system requirements of the home computer 36 (FIG. 1) and may include a link 92 that opens a sample .pdf. The sample .pdf may be activated by the applicant and may display an alphanumeric passcode, which may be entered by the applicant in window 94. After this step is completed, the applicant may click the “Next” button 96. The step of opening the sample .pdf file to obtain the passcode is indicated at block 98 in FIG. 4. The purpose of the display step of block 90 is to verify that the applicant is able to print the loan documents, since applicable lending regulations may require that the applicant have the ability to retain a printed copy of the loan documents at the end of the process. At decision diamond 100, if the applicant elects not to bypass the “.pdf test” of block 98, the applicant enters the passcode at block 102 and, as shown at decision diamond 104, if the passcode or “Password” is correct, the applicant may progress to decision diamond 106. If, on the other hand, the passcode is not correct, as shown in decision diamond 108, the display page may be shown to the applicant again, as indicated at block 110.

The applicant may be given three attempts to display a correct passcode. However, if the applicant is unsuccessful each time, as shown at block 112, the applicant may be directed to a “Getting Started” page with a wet sign message that guides him through a “wet sign” process. In the alternative, an applicant may elect to bypass the .pdf test, indicated at decision diamond 100, in which case the applicant agrees to the lender forwarding copies of executed documents to him or her at the end of the process.

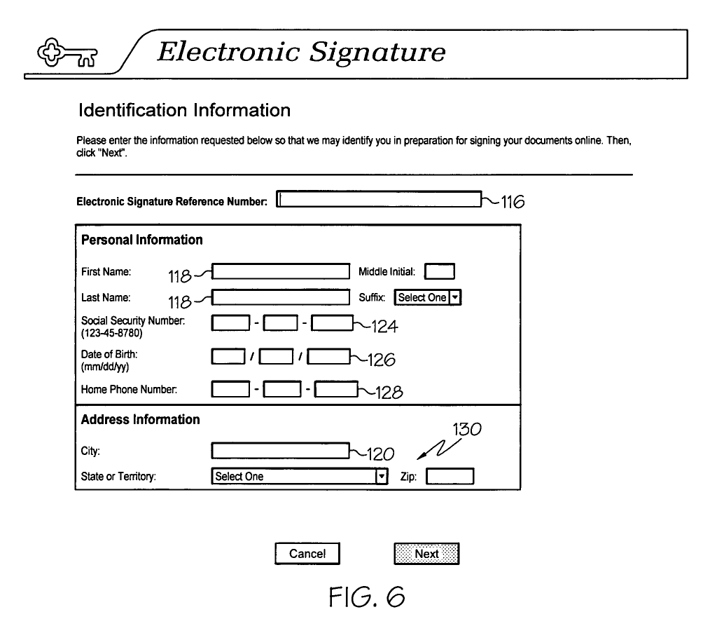

If the applicant is proceeding continuously, then, as shown in block 114 and on FIG. 6, the applicant fills in the electronic signature reference number in box 116, the first and last name in boxes 118 and the Social Security number in box 124. Alternatively, if the applicant is proceeding in a broken flow; that is, if the applicant interrupted the process and returned to block 86 by way of the earlier-supplied link and e-sign reference number, then the page 122 (FIG. 4) is displayed, which is the same as FIG. 6 but may require additional information, for example, the city in box 120, date of birth in box 126 and home phone number in box 128. The applicant may also be required to fill out the additional address information in boxes 130. This step is represented by block 132 in FIG. 4.

As shown by decision diamond 134, if there are no validation errors, the applicant may proceed to the “Validate Registration” process indicated at block 136. In the alternative, if there are validation errors, the applicant may be directed back to blocks 114 or 122 as appropriate and instructed to correct the information.

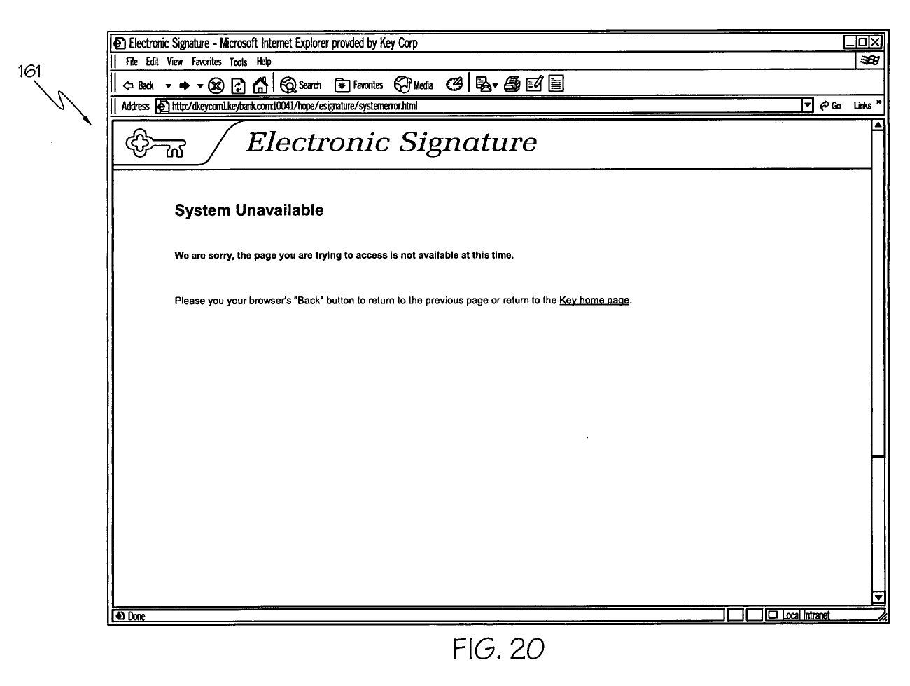

The “Validate Registration” process of block 136 may involve the application server 16 validating, for example, that the reference number entered in block 116 is correct, that the status of the deal is correct, the Social Security number entered in block 124 is correct or that the Social Security number has been registered with respect to the deal. If the information is not validated, as indicated in decision diamond 137, an error message is displayed at block 160 and shown in FIG. 20 and the e-signature process ends. If the information is validated, the process proceeds to block 138 at which time the registration process is validated with respect to matching the data elements with respect to the data elements entered by the applicant at the beginning of the process at block 48 of FIG. 2.

As shown at decision diamond 140, if the registration check is successful, the applicant proceeds with the process; if the registration check is not successful, as shown by decision diamond 142, and block 144, the applicant is given two additional tries to provide the correct information. If the applicant is not successful after three tries, as shown by block 146, the applicant is shown a page advising him or her to “call Customer Service” and the process ends.

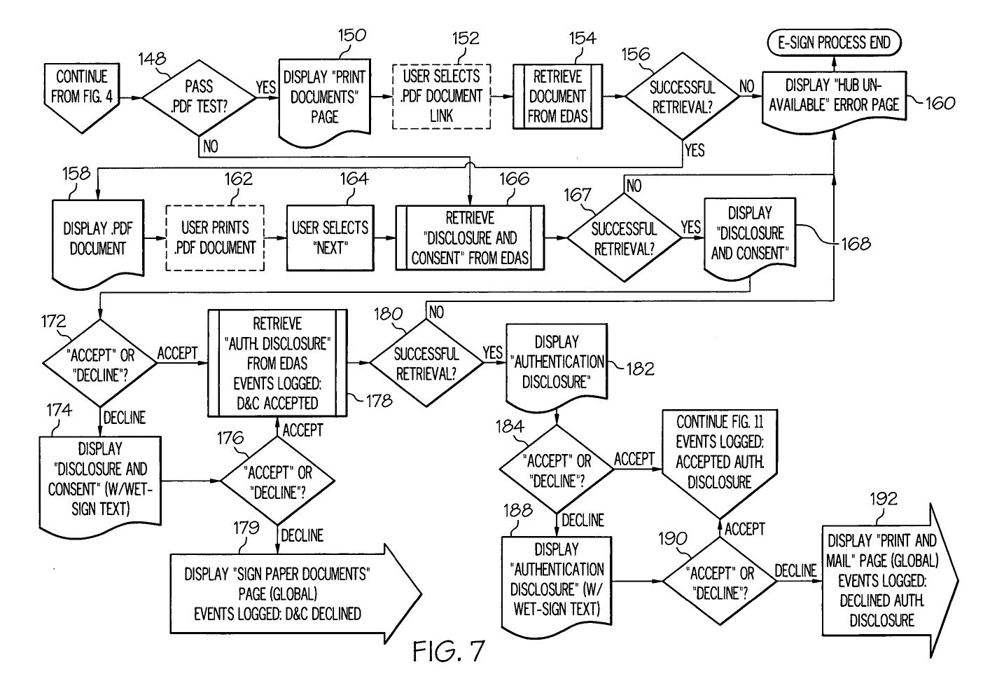

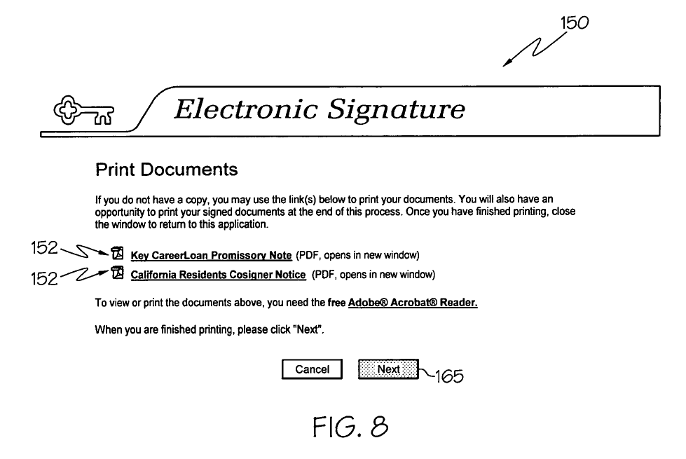

As shown in FIG. 7, if the applicant has passed the .pdf test shown in FIG. 5, then as shown at decision diamond 148, the application server 16 may display a “Print Documents” page indicated at block 150 and shown in FIG. 8. The applicant then selects the appropriate link to open a .pdf file of the promissory note that embodies the loan, shown at block 152, and indicated at links 152 in FIG. 8. As shown in FIG. 1, and as indicated in block 154 in FIG. 7, the application server 16 retrieves the appropriate document template from document template application server 22, which has various document templates for that product stored in storage 24. An example of an electronic document retrieval that may be employed system is shown in U.S. Ser. No. 10/318,342 filed Dec. 12, 2002, the disclosure of which is incorporated herein by reference.

If the retrieval is successful, as indicated at decision diamond 156, the document may be displayed, preferably as a .pdf file, as indicated at block 158. In the alternative, if the retrieval is not successful, a “System Unavailable” error page, indicated at block 160 and shown in FIG. 20 as page 161, may be shown and the e-sign process ends. As shown in block 162, the applicant has the option of printing the document using home printer 38 (FIG. 1).

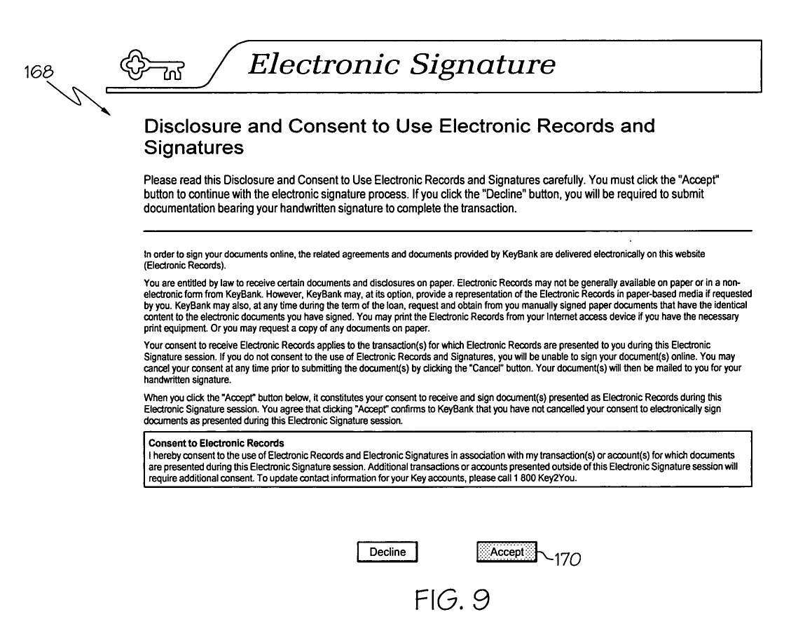

As indicated in block 164, the applicant may click the “Next” button, also shown in FIG. 8 as button 165, and the process proceeds to block 166 at which the “Disclosure and Consent to Use Electronic Records and Signature” document page 168 is produced, as shown in FIG. 9. If the retrieval of the document page 168 is successful, as indicated at decision diamond 167, the page 168 may be displayed and the applicant may be given an opportunity to accept or decline the terms of the disclosure by clicking the appropriate button at 170 (FIG. 9). This step is indicated at decision diamond 172 in FIG. 7. If the retrieval is not successful, as indicated at block 160, the system displays a “System Unavailable” error page 161 (FIG. 20) and the e-signature process ends.

Alternatively, if the applicant elects not to accept the terms of the Electronic Signature Disclosure at 168, the application server 16 displays page 174, which is a modified “Disclosure and Consent Form” with a “wet sign” text, retrieved from server 22 that retains it in storage 24. If the applicant accepts that version, then, as indicated at decision diamond 176, the system may retrieve the “Authentication Disclosure” document as indicated in block 178. If the applicant declines, then the applicant is asked to print and wet sign the loan note and the process ends, as indicated at block 179.

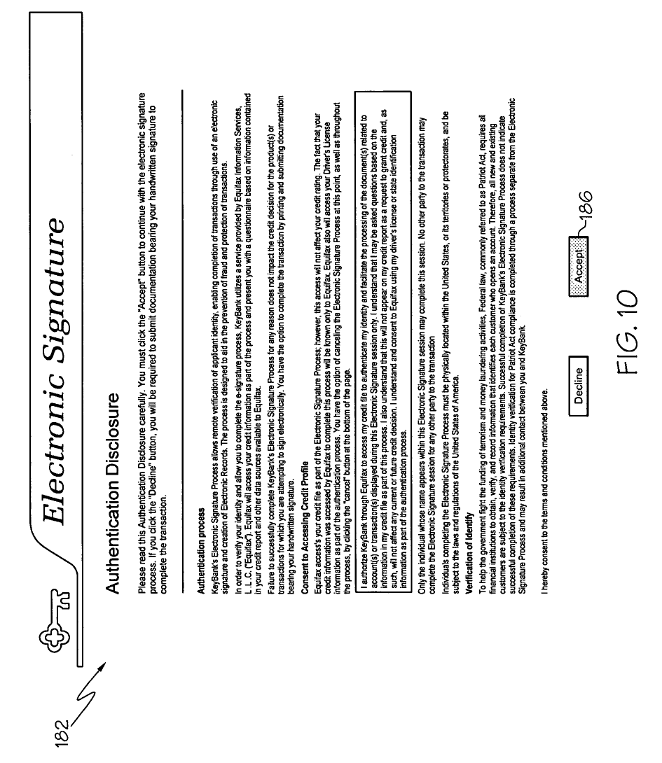

If the retrieval is successful, then, as indicated at decision diamond 180, the process may display the “Authentication Disclosure” page 182, also shown in FIG. 10. If retrieval is not successful, the applicant may be shown an error message 161 (FIG. 20) (block 160 in FIG. 7) and the electronic signature process ends. Again, in decision diamond 184 the applicant may be asked to accept or decline the terms of the authentication disclosure, which relate to the applicant's giving permission to the lender or other document provider to obtain confidential information regarding the applicant of a non-wallet-type in order to verify the identity of the applicant and establish that the person providing the information is actually the individual named in the application. If the applicant accepts, by clicking the appropriate button 186, the process may continue. If the applicant declines, then an “Authentication Disclosure” with a “wet sign” text page may be displayed, as indicated at 188, and the applicant may print out that page and wet sign it, as indicated at decision diamond 190. If the applicant accepts that version and elects to proceed with the e-signature process, then, as indicated at decision diamond 190, the process may continue. If the applicant elects not to proceed, then, as indicated in block 192, the applicant is invited to print, sign and mail the documents to the lender or other document provider.

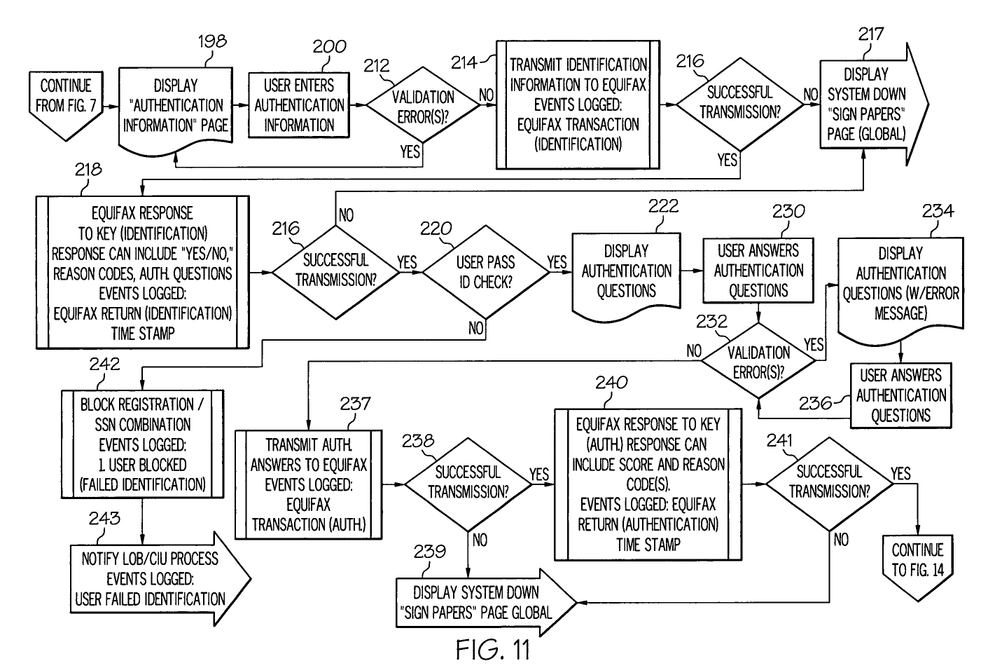

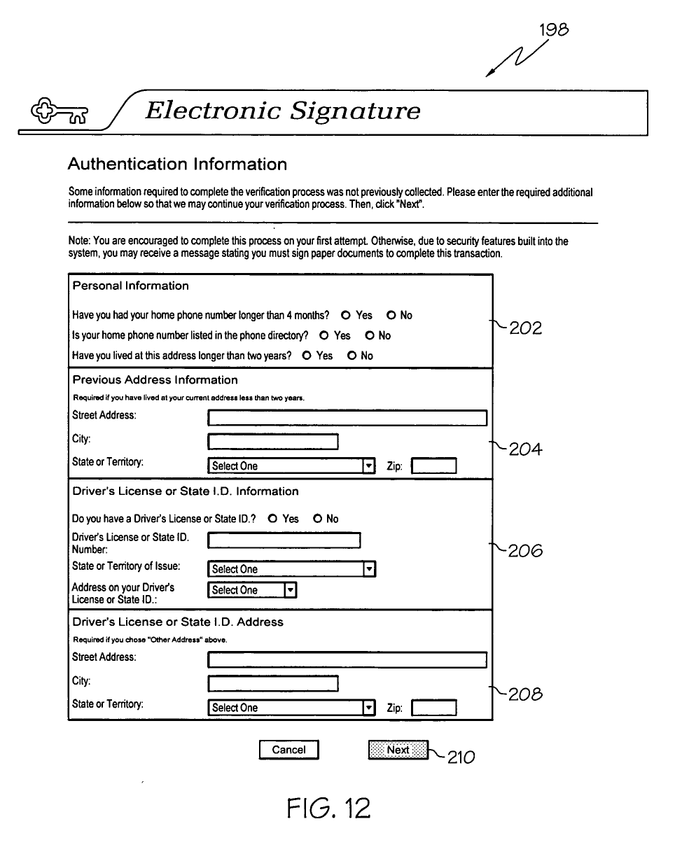

As shown in FIG. 11, an “Authentication Information” page 198 may be displayed, also shown as page 198 in FIG. 12, which is transmitted from server 26 (FIG. 1). As indicated in block 200, the applicant may enter personal information, such as, for example, regarding home telephone in box 202 in FIG. 12, previous address information in box 204, driver's license number or state identification information number in box 206 and driver's license or state identification information address in box 208. When completed, the applicant may click the “Next” button 210 and, as indicated in FIG. 11, the process proceeds to decision diamond 212 in which the information is validated.

If the information passes the validation test, as indicated in block 214, the information may then be transmitted from the e-sign application server 16 to authentication application server 26 (FIG. 1), which may be operated by a third party service provider such as Equifax, Inc., that will authenticate that information as being appropriate for the applicant. If, as shown in decision diamond 216, the transmission is not successful, the authentication application server 26 may display a page indicating that the system is down and inviting the applicant to print, sign, and mail the signed documents to the lender, as indicated in block 217. If the transmission is successful, the authentication server 26 may provide a response, indicated at block 218, to the server 16. The response will either be “Yes” or “No”; if the latter, codes indicating the reasons for stopping the process may be provided to the system 10 (FIG. 1), and the applicant may be directed to complete the application by way of the wet sign process, as indicated in block 217.

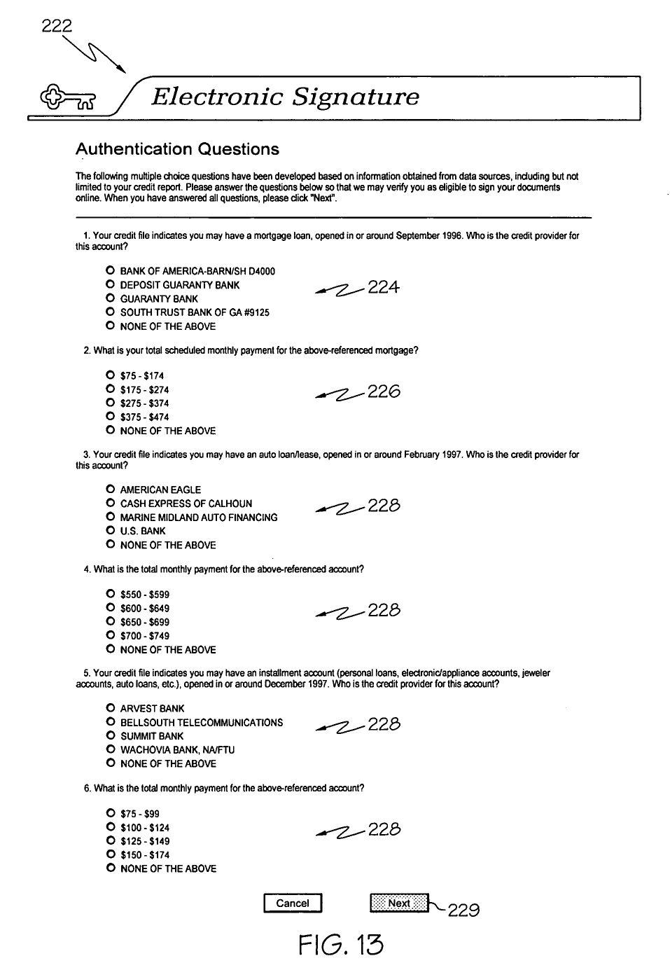

If the response is favorable, then authentication questions may be transmitted from the authentication server 26 through the middleware server 20 to the e-sign application server 16. As shown in FIG. 11, at decision diamond 220, if the identification information is accurate, the application server 12 then may display several multiple-choice authentication questions, indicated at block 222 and shown in FIG. 13 as document 222. The multiple-choice questions typically may be non-wallet-type, such as the name of the credit provider indicated at 224, monthly car payment range indicated at 226 and, as shown at 228, questions regarding other financial institutions that have provided financial loans or other services to the applicant. After answering the questions 224 - 228, applicant then clicks the “Next” button 229 to proceed.

As indicated in block 230 in FIG. 11, the applicant may answer the questions provided by clicking on the appropriate answer on page 222. As shown at decision diamond 232, if there are validation errors (i.e., if there are one or more questions that are not answered), the questions may be displayed at block 234, the applicant may answer the questions at block 236 and the process proceeds to block 237, where the answers are transmitted to the authentication application server 26 (FIG. 1). If the transmission is not successful, as indicated in decision diamond 238, the system may display an error page, indicated at block 239, in which the applicant is invited to print, sign and mail the loan documents to the lender. As indicated at block 240, if the transmission is successful, the authentication application server 26 may communicate to the financial institution the favorable results over network 34 to middleware application server 20 and e-sign application server 16. As indicated at decision diamond 241, if the transmission is not successful, the applicant is given an opportunity to print, sign and mail the documents, indicated at block 239.

If, at decision diamond 220, the identification check is failed by the applicant, as indicated in block 242, the application server 16 may block the applicant from further attempts to complete the electronic loan application process under the given identification number and Social Security number combination. And, as indicated at block 243, an alert is sent to the line of business and consumer fraud investigation unit.

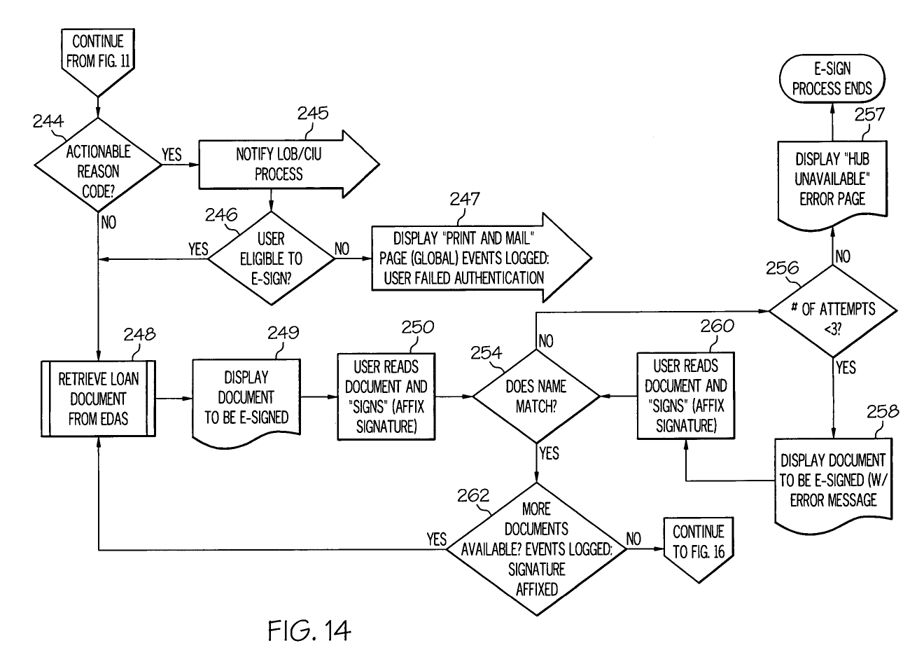

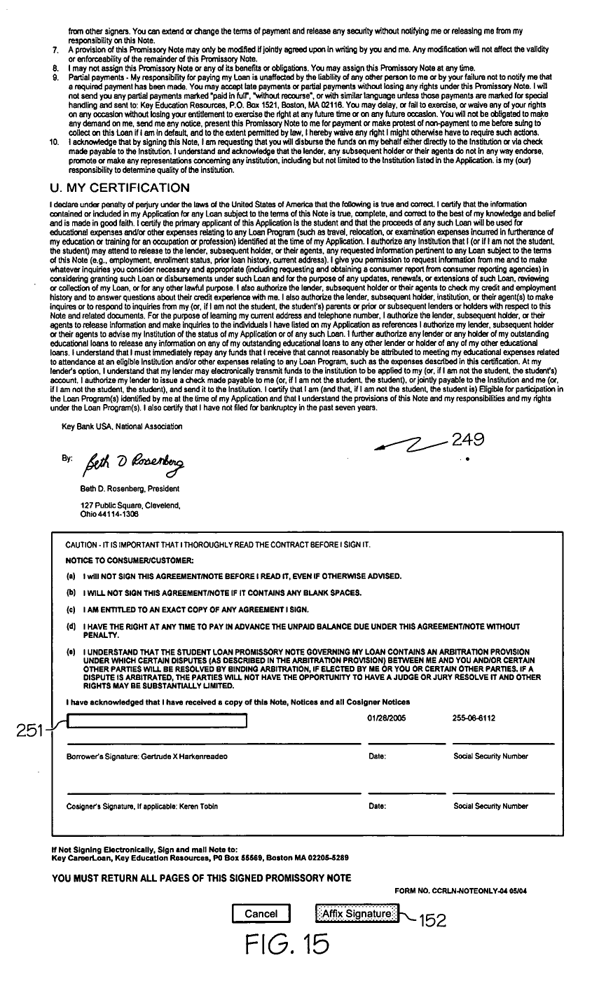

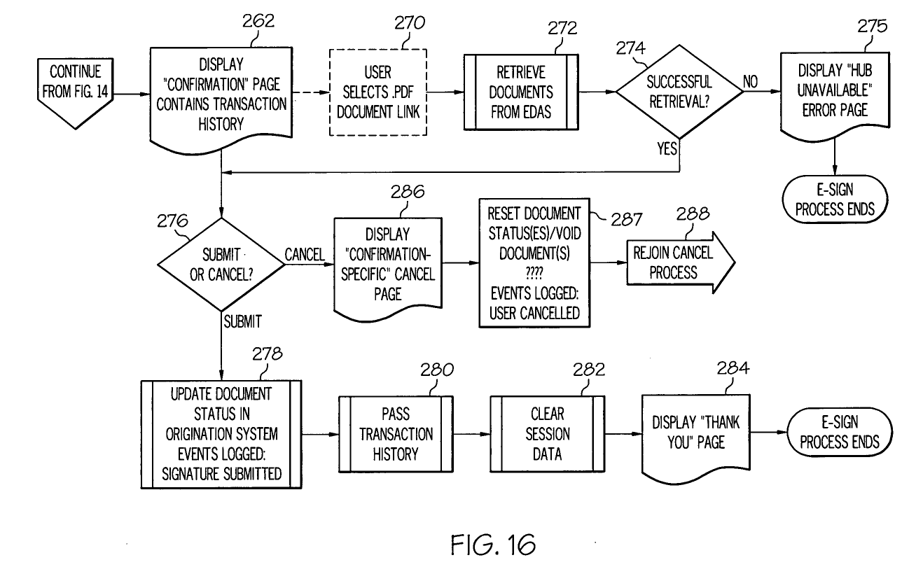

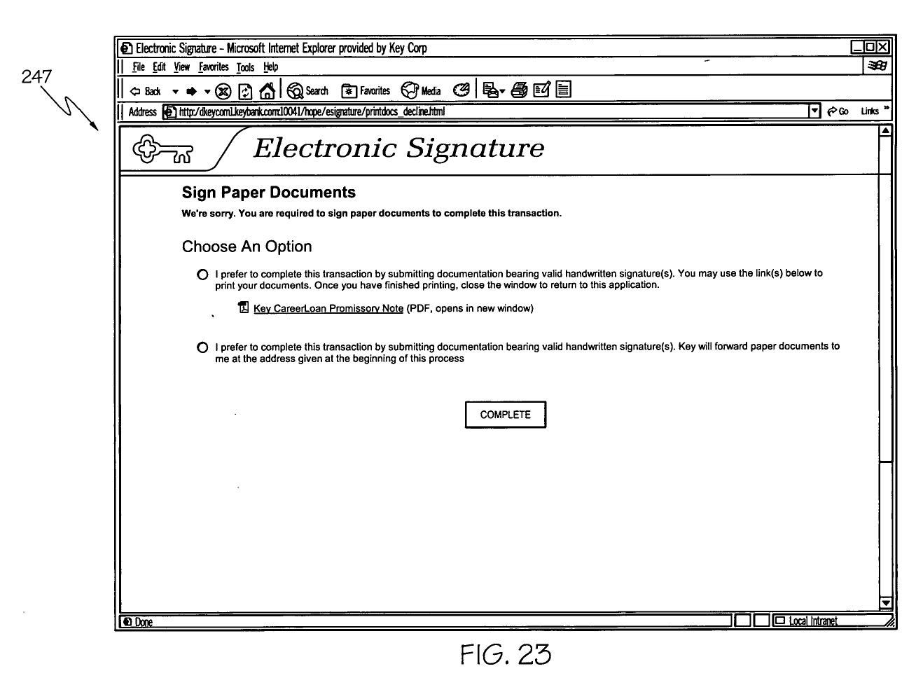

If, as shown in decision diamond 244 in FIG. 14, the authentication application server 26 returns an actionable reason code, the code is sent to the consumer fraud investigation unit of the line of business, shown at block 245, and as shown at decision diamond 246, depending on the severity of the reason code, the applicant is either directed to print, sign and mail the documents, shown in block 247, or proceed to block 248. If the former, then applicant is shown page 247 of FIG. 23. However, as shown at decision diamond 244, if there is no actionable reason code received by the system from the authentication application server 26 (FIG. 1) whose identified action is to stop the process, or the actionable reason code is not severe, the process may proceed to block 248 at which the application server 16 retrieves the appropriate loan document from document template application server 22, where it may reside in storage 24. As shown in block 249, the document is displayed at applicant's computer 36 or workstation 42 and may appear as shown in FIG. 15 as document 249. Document 249, in this example and by way of illustration only, is a promissory note that relates to an education loan and includes all of the aspects of a promissory note including the loan number, date the loan was made, borrower's name and loan amount.

As indicated in block 250 of FIG. 14, the applicant may read the note and then electronically sign it by affixing his or her electronic signature in box 251, as shown in FIG. 15. The applicant may then click the “Affix Signature” button 252 and, as shown in decision diamond 254, the application server 16 (FIG. 1) may determine whether the name on the signature line matches the name of the applicant.

As indicated at decision diamond 256, the applicant may be given three tries to provide the appropriate signature. As before, if the applicant fails three times, error page 161 may be displayed (FIG. 20), as indicated at block 257. This involves matching the data inputted to the data received when the document(s) were registered (i.e., first, middle and last names and applicable suffixes). If a signature is incorrect, an appropriate document with error messages may be displayed, as indicated at block 258, which would give the applicant the opportunity to read the document again, indicated at 260, and the process proceeds. If additional documents are required, then at decision diamond 262, the process may retrieve additional documents from the template application server indicated at block 244 and the process proceeds as before with each additional document.

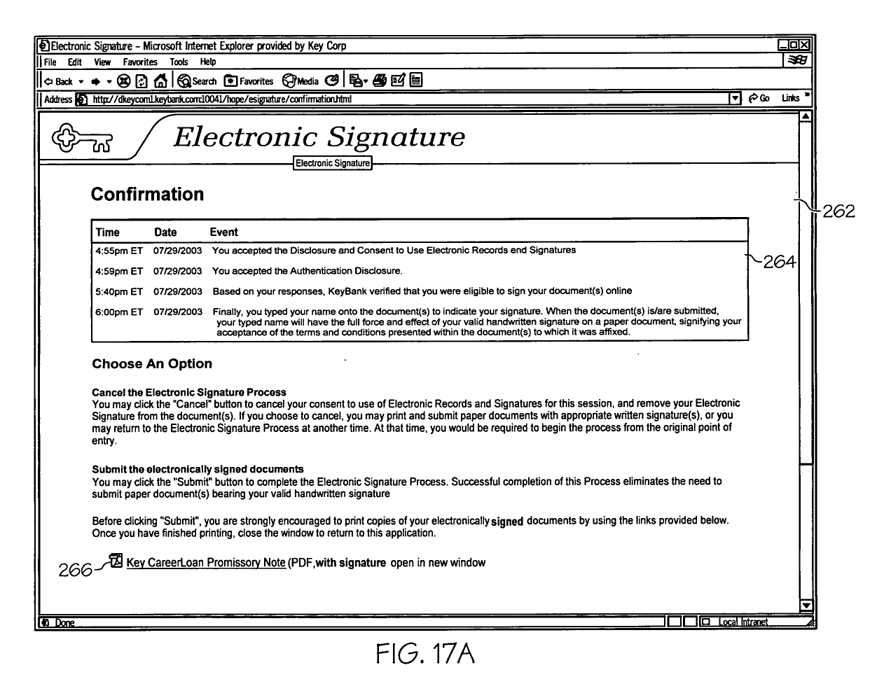

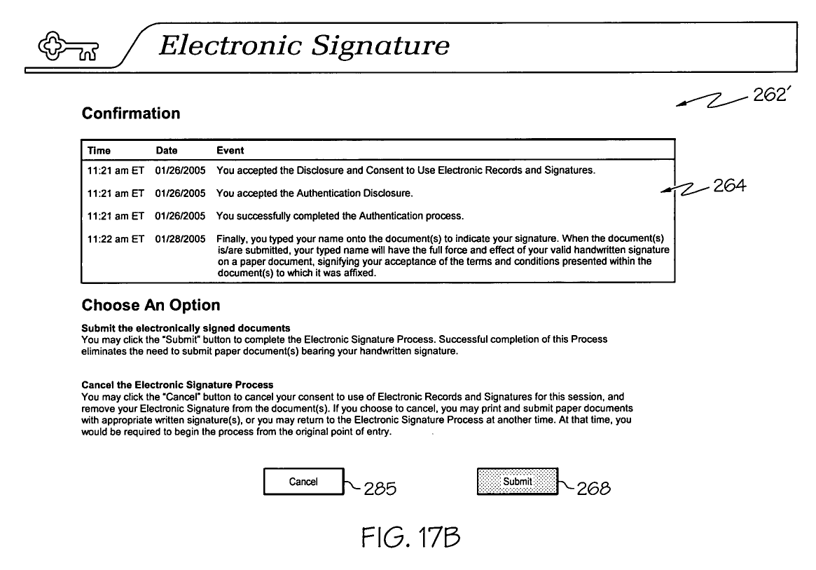

As shown in FIG. 16, at block 262, the application server 16 (FIG. 1) displays the “Confirmation Page,” shown as page 262 in FIG. 17. That confirmation page may include a box 264 displaying the history of the transaction, a link 266 to a downloadable .pdf image of the loan note and a “Submit” button 268 (see FIG. 17A, but also present on page 262 of FIG. 17). As indicated in box 270 in FIG. 16, the applicant may activate link 266 (see FIG. 17) to view the promissory note, which is retrieved from server 22 (FIG. 1), as shown in block 272. If the applicant failed or bypassed the .pdf test (see block 100, FIG. 4 and page 90, FIG. 5), page 262′ of FIG. 17A, which is identical to page 262 of FIG. 17 but lacks the link to the .pdf image, may be displayed.

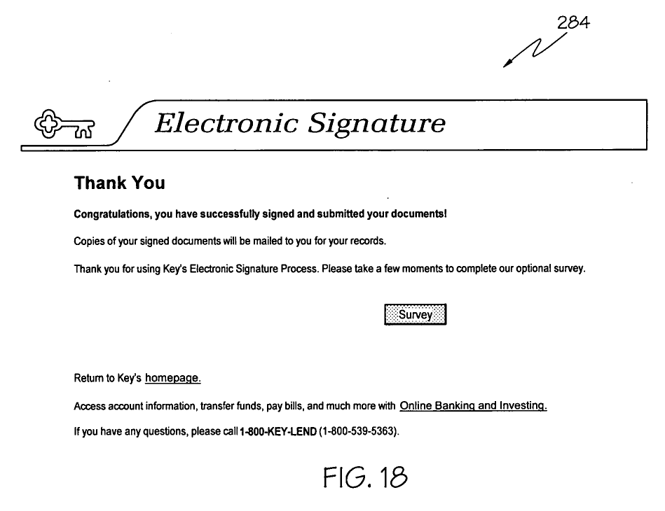

If the retrieval of the loan note as a result of applicant clicking link 266 of FIG. 17 is not successful, then, as indicated at block 275, error page 161 (FIG. 20) may be displayed and the process ends. If retrieval is successful, then, as indicated in decision diamond 276, the applicant clicks the “Submit” button 268. In the alternative, the applicant may elect not to print the loan documents (i.e., not to click link 266 of FIG. 17) and instead proceed directly to decision diamond 276. Clicking the “Submit” button 268 (shown in FIG. 17A) may move the applicant to the next step in the process, in which the document status may be updated in the system, indicated at block 278, the transaction history passed, indicated at block 280, and the session data cleared, indicated at block 282. A “Thank You” page 284 may be displayed, as shown in FIG. 18.

Referring back to decision diamond 276 in FIG. 16, if applicant clicks the “Cancel” button 285 (FIG. 17), then as indicated at block 286, a confirmation specific cancel page is displayed, and the documents are voided as indicated in block 287 and the cancellation process is rejoined, as indicated in block 288.

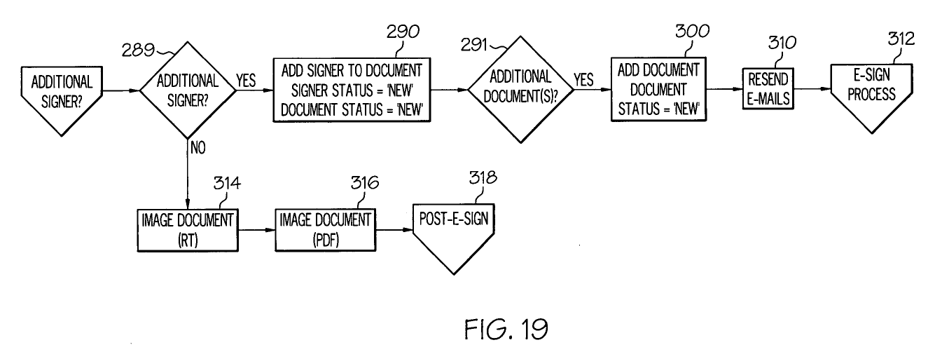

Once the process has been completed for the applicant, if a co-signer or additional signer is required or requested by the applicant, then the process may continue as indicated in FIG. 19 at decision diamond 289. If the answer is in the affirmative, then at block 290, the co-signer may be added to the document 249 (FIG. 15), and as indicated at decision diamond 291, if additional documents are needed, they may be added, as indicated at block 300. As indicated at block 310, an e-mail may be sent to the co-signer with the appropriate identification number for the transaction and the appropriate link for the co-signer to access the e-sign web pages 84 provided by e-sign application server 16 (FIG. 1). An advantage of this aspect of the process and system 10 is that the co-signer need not be geographically close to the applicant or participate at the same time as the applicant. Rather, the co-signer may elect to participate at a place and time of his or her own choosing.

As indicated by block 312, the e-sign process for the co-signer may proceed as it did for the applicant as described above. Specifically, the co-signer may access the system 10 by way of the e-mailed link and provides the supplied identification number and requisite identification information to proceed with verification of identity. The co-signer then may consent to providing authentication information, the identity of the co-signer may be authenticated through the use of multiple-choice questions dealing with non-wallet-type information, and if properly authenticated, the co-signer may provide an electronic signature to the loan document.

An additional benefit of the present invention is that the co-signer may, at any time, elect not to proceed with an electronic signature and instead “wet sign” a loan document by printing the document at a printer associated with the computer at which the co-signer accesses the e-sign application server 16.

As indicated at decision diamond 289, if an additional signer is not required, the process proceeds to block 314, in which the document image is time stamped, hashed and is stored in storage 18 (FIG. 1) by server 16. In addition, as shown in block 316, a .pdf image of the document is created and stored in image storage 30 by server 28 for purposes of subsequent retrieval and viewing by the applicant. The same storage procedure would occur and be included in block 312 (FIG. 19) for a co-signed document.

As indicated at block 318, once the document has been stored in storage 18 and storage 30, the process ends, save for management of the archived documents in storage 18, 30, which may include purging files, monitoring retention periods, preparing loan portfolios for sale to other entities and the like.

While the forms of apparatus described herein constitute preferred embodiments of the method and system for electronically signing a document, it is to be understood that these embodiments are presented by way of explanation and not limitation, and that changes may be made therein without departing from the scope of the disclosure.

What is claimed is:

1. A method for electronically signing a document comprising the steps of:
accessing over a network a product page provided by a product application server;
providing identification information to said product application server unique to an individual who is to sign said document;
communicating information identifying a document to be electronically signed from said product application server to an electronic signature application server;
verifying said individual's identity;
acquiring a template of said document and populating said template with data pertaining to said individual to form a completed document and displaying said completed document on a page generated by said electronic signature application server and accessible over a network by said individual; and
adding an electronic signature to said completed document to form a signed document.

2. The method of claim 1 further comprising the step of storing an image of said signed document.

3. The method of claim 1 further comprising the steps of time stamping and hashing said document template, said electronic signature and said data pertaining to said individual; and storing said time stamped and hashed document template, electronic signature and data pertaining to said individual.

4. The method of claim 2 wherein said storing step includes the step of transmitting a copy of said signed document to an imaging application server and storing said copy in storage associated with said imaging application server.

5. The method of claim 4 wherein said storing step includes the step of converting said copy to a .pdf format file and storing said .pdf format file.

6. The method of claim 5 wherein said storing step includes the step of storing said .pdf format file in storage associated with said imaging application server.

7. The method of claim 1 wherein the step of adding an electronic signature includes the step of providing an option to said individual of printing said completed document for wet signature.

8. The method of claim 7 wherein said step of providing an option of printing said completed document includes the step of, in response to an election to print and wet sign said completed document, communicating an election to wet sign said completed document from said electronic signature application server to said product application server and subsequently communicating an instruction to delete said completed document from said product application server to said electronic signature application server.

9. The method of claim 1 further comprising the step of determining, as a result of verifying said individual's identity, whether an additional signature from a second individual is required on said document.

10. The method of claim 9 wherein said step of verifying said second individual's identity includes the step of obtaining personal information of said second individual from a third party not a party to said document.

11. The method of claim 10 wherein said step of obtaining personal information includes the step of obtaining said personal information from an authentication application server.

12. The method of claim 9 further comprising the step of communicating to said second individual said document identification information, thereby enabling said second individual to access said document over a network.

13. The method of claim 12 further comprising the step of providing said second individual an option of either providing a signature electronically to said document or printing said document locally relative to said second individual for a wet signature.

14. The method of claim 9 further comprising the step of, subsequent to said second individual identity verification step, adding an electronic signature of said second individual to said completed document to form a co-signed document with signatures of said individual and said second individual.

15. The method of claim 14 further comprising the step of storing an image of said co-signed document.

16. The method of claim 15 further comprising the steps of time stamping and hashing said document, said electronic signatures and said data pertaining to said individual and said second individual; and storing said time stamped and hashed document, electronic signatures and data pertaining to said individual and said second individual.

17. The method of claim 15 wherein said storing step includes the step of transmitting a copy of said co-signed document to an imaging application server and storing said copy in storage associated with said imaging application server.

18. The method of claim 17 wherein said storing step includes the step of converting said copy to a .pdf format file and storing said .pdf format file.

19. The method of claim 18 wherein said storing step includes the step of storing said format file in said storage associated with said imaging application server.
